(19) United States
(12) Patent Application Publication
(10) Pub. No.: US 2017/0008185 A1
(43) Pub. Date: Jan. 12, 2017

(54) DIE-CUTTING SCRAP REMOVAL DEVICE

(71) Applicants: Byung-jun SONG, Seoul (KR); Ju-hyun SONG, Seoul (KR)

(72) Inventors: Byung-jun SONG, Seoul (KR); Ju-hyun SONG, Seoul (KR)

(21) Appl. No.: 15/113,535

(22) PCT Filed: Apr. 28, 2014
(86) PCT No.: PCT/KR2014/003735

§ 371 Date: Jul. 22, 2016

(30) Foreign Application Priority Data
Jan. 22, 2014 (KR) 10-2014-0007547

(51) Int. Cl. B26D 7/18; B31B 1/20; B26F 1/40

(52) U.S. Cl. CPC B26D 7/1818; B26F 1/40; B31B 1/20; B26F 1/44

(57) ABSTRACT

The die-cutting scrap removal device of the present invention relates to a die-cutting scrap removal device (1) for separating a product (P) from an original plate (NP), the device comprising a scrap removal means (100) including: a table-shaped removal main body part (110) standing upright on the ground surface; a fixed pressing-separation part (120) fixed on the top surface of the removal main body part (110) so as to move vertically; and a movable pressing-separation part (130) moving in the back and forth directions and the vertical direction on the top surface of the removal main body part (110), and thus the device includes the scrap removal means comprising the fixed pressing-separation part for moving vertically and the movable pressing-separation part for moving vertically and moving in the back and forth directions behind the fixed pressing-separation part, thereby readily separating scraps in mass quantities of products.

### CROSS-REFERENCE TO RELATED APPLICATION

This application claims under 35 U.S.C. §119(a) the benefit of priority to Korean Patent Application No. 10-2014-0007547 filed on Jan. 2, 2014, the entire contents of which are incorporated herein by reference.

### BACKGROUND

Technical Field

The present invention relates to a die-cutting scrap removal device, and in particular to a die-cutting scrap removal device which is provided with a scrap removal part formed of a fixed pressing-separation part configured to vertically move for a product and scraps to easily separate from a plurality of die-cut original plates, and a movable pressing-separation part configured to move vertically and back and forth behind the fixed pressing-separation part, wherein an elevating cylinder part and an elevating rotary shaft unit, which performs the function of a rotary shaft, are disposed at a lower portion in order for the movable pressing-separation part to rotate at a predetermined angle.

Background Art

In recent years, a product used, for example, in engineering, industrial and actual life sectors is being manufactured in various sizes and shapes. To this end, a packing box configured to pack such a product is being manufactured in various sizes and shapes.

The packing box, in general, is configured in a polyhedron structure wherein a product is accommodated. The packing box may be formed in such a way that a raw material, for example, a thick paper is cut into a plane planar figure, and the cut plane planar figure is folded. The cutting of a plane planar figure the size and shape of which have been previously set, is called a die-cutting.

FIG. 1 is a planar view illustrating in a die-cut packing box. As evident from FIG. 1, a lot of packing box planar figures are die-cut on one original plate 2. In the course of the die-cutting wherein the material gets impressed, a cutting procedure is, in general, carried out in such a way that predetermined portions are connected, not cutting the front side of a planar figure, so as to prevent a corresponding planar figure of the packing box from separating from the original plate after the cutting has been just carried out.

When one packing box is manufactured on an original plate wherein a lot of packing box planar figures have got impressed, a procedure to individually separate a die-cut planar figure, namely, a packing box and a scrap, is necessarily carried out. This procedure should be manually carried out by a worker. For this reason, the worker should inevitably perform a lot of works in case of a mass production, which may lead to increased labor costs, thus consequently causing a problem in terms of the mass production.

The same applicant as the present invention invented the Korean patent laid-open No. 10-2012-0117179 in an effort to solve the aforementioned problem.

FIG. 2 is a side view illustrating a conventional die-cutting scrap removal device. The aforementioned conventional die-cutting scrap removal device is formed of a frame shelf 3 on which the original plates 2 the planar figure of which has been die-cut, are mounted as illustrated in FIG. 2, presses 4, 5 and 6 which descend from above the frame shelf 3 and pressurize the original plates 2, and a separation shelf 7 which moves upward or downward from the frame shelf 3 in a state where a part of a corresponding original plate 2 has moved and fixed by the presses 4, 5 and 6, thus separating a part of the corresponding original plates 2.

In the conventional die-cutting scrap removal device, a separation work should be carried out with the aid of only a plurality of presses which are configured to move at different heights, respectively, when a product and scraps are separated from a plurality of stacked original plates 2, for which the products may be partially ripped off or damaged since the product and the scraps are not accurately separated.

### SUMMARY OF THE DISCLOSURE

The present invention has been made in an effort to solve the above-described problems associated with prior art. It is an object of the present invention to provide a die-cutting scrap removal device which is provided with a scrap removal part formed of a fixed pressing-separation part configured to vertically move for a product and scraps to easily separate from a plurality of die-cut original plates, and a movable pressing-separation part configured to move vertically and back and forth behind the fixed pressing-separation part, by means of which scraps can be easily separated from a lot of scraps. A forward and backward movement guide bar and a forward and backward movement guide plate are disposed at both sides of the movable pressing-separation part, so the movable pressing-separation part can be easily moved in the forward and backward directions. A pressing pin protruding in one direction or a plane is formed at one surface thereof, whereby a pressing body can be defined, which is able to rotate in response to a predetermined operation, thus preventing any damage to the product during the separating work of the scraps. An elevating cylinder part and an elevating rotary shaft part which is configured to perform the function of a rotary shaft are disposed below the movable pressing-separation plate, so the movable pressing-separation plate can be movable at a predetermined angle.

To achieve the above objects, there is provided a die-cutting scrap removal device configured to separate a product from an original plate on which a plurality of products have been die-cut, which may include a scrap removal means which includes a table-shaped removal main body part which stands upright on the ground, a fixed pressing-separation part which is fixed on the upper surface of the removal main body part and is configured to move vertically, and a movable pressing-separation part which is able to move back and forth and vertically on the upper surface of the removal main body part, wherein the fixed pressing-separation part includes a fixed pressing plate on which an original plate loaded on the top of the removal main body part, is mounted, a fixed pressing part which moves vertically above the fixed pressing plate and is connected passing through for the original plate to be pressed, and a fixed pressing cylinder which is disposed below the fixed pressing plate and is configured to move vertically the fixed pressing part, and wherein the movable pressing-separation part includes a movable pressing plate which is disposed horizontal behind the fixed pressing plate and is configured to move back and forth, a movable pressing part which is configured to move vertically above the movable pressing plate and is connected passing through for the original plate to be pressed, and a movable pressing cylinder which is disposed below the movable pressing plate and is configured to move vertically the movable pressing part.

A pair of fixed vertical shaft rods are disposed at the fixed pressing-separation part so as to guide the vertical movements of the fixed pressing part, and a fixed pressing transfer plate is disposed at a lower end portion of the fixed vertical shaft rod and is connected to the fixed pressing cylinder and is able to move the fixed pressing part, and a pair of movable vertical shaft rods are disposed at the movable pressing-separation part so as to guide the vertical movement of the movable pressing part, and a movable pressing transfer plate is disposed at a lower end portion of the movable vertical shaft rod is connected to the movable pressing cylinder and is able to move the movable pressing part.

The fixed pressing part includes a quadrangular rod-shaped fixed pressing body, a [symbol] -shaped fixed pressing body frame to which both ends of the fixing pressing body are connected rotatable, and a fixed rotation motor which is disposed at one side of the fixed pressing body frame and is configured to rotate the fixed pressing body, and the movable pressing part includes a quadrangle rod-shaped movable pressing body, a [symbol] -shaped movable pressing body frame to which both ends of the movable pressing body are connected rotatable, and a movable rotation motor which is disposed at one side of the movable pressing body frame and is able to rotate the movable pressing body.

A pin fixing surface is formed at one surface of each of the fixed pressing body and the movable pressing body, wherein the pin fixing surface is formed of a pressing pin which allows one point of the original plate to be pressed and fixed, and a pin engaging hole which is formed inwardly concave for the pressing pin to be fixed, and a plane fixed surface is formed at the other surface thereof for another point of the original plate to be pressed and fixed.

The pressing pin includes a mounting part which is mounted on the pin fixing surface, and a pressing part which is bent at a right angle at an end portion of the mounting part, and a longitudinal bolt through hole is formed at one surface of the mounting part for an engaging bolt to pass through the longitudinal bolt through hole.

An engaging groove is formed at an inner side of the pin engaging hole, wherein the engaging groove is formed outwardly concave, and an engaging nut is provided at the engaging groove and is engaged with the engaging bolt, wherein the engaging nut is larger than the inner diameter of the pin engaging hole for the pressing pin to be fixed.

A forward and backward movement guide bar is formed at both sides of the movable pressing plate while protruding in the direction of the fixed pressing plate, wherein a slide insertion hole is formed inside the forward and backward movement guide bar, and a plate-shaped forward and backward movement guide plate is disposed on the upper surface of the removal main body part, wherein the slide insertion rod inserted in the slide insertion hole is formed horizontal, and a forward and backward movement cylinder is provided below the forward and backward movement guide bar and is configured to push the forward and backward movement guide plate.

A rotation hinge part is disposed at an end portion of the forward and backward movement guide bar while being fixed at both sides of the movable pressing plate so as to rotate in the upward and downward directions of the movable pressing plate, wherein the rotation hinge part is hinged at an end portion of the forward and backward movement guide bar.

An elevating cylinder part is disposed at the lower surface of one side of the movable pressing plate and is configured to elevate the movable pressing plate in order for the movable pressing plate to move at a predetermined angle. An elevating rotary shaft part is disposed at an upper end portion of the elevating cylinder part and is connected to the movable pressing plate so as to rotate during the elevating operation.

### Advantageous Effects

The die-cutting scrap removal device according to the present invention has the following advantageous effects.

First, since the die-cutting scrap removal device is provided with a scrap removal part formed of a fixed pressing-separation part configured to vertically move for a product and scraps to easily separate from die-cut original plates, and a movable pressing-separation part configured to move vertically and back and forth at the same time behind the fixed pressing-separation part, a work to separate scraps from a lot of products die-cut on the original plate can be readily carried out, which may result in an increased production rate.

Second, a forward and backward movement guide bar is provided, wherein a slide insertion hole is formed at both sides of the movable pressing-separation part, and a forward and backward movement guide plate is provided, wherein a slide insertion rod inserted in the slide insertion hole is formed at a removal main body part, by means of which it is possible to prevent a movement trajectory from being deformed when the movable pressing-separation part moves back and forth, thus allowing the movable pressing-separation part to operate accurately.

Third, there are provided a pin fixing surface to which a pressing pin is engaged so as to enhance a fixing force at a surface during the pressing and fixing of the original plate, and a plurality of pressing bodies disposed at the other surface, wherein a plane fixing surface is formed to prevent any damage to the surface of the product. Any damages to the products, therefore, can be prevented during the work to separate the scraps from the products by variably rotating the pressing body in such a way that the side where the products position is pressed by the plane fixing surface during the pressing and fixing of the original plate, and the side where the scraps position is pressed by the pin fixing surface.

Fourth, there are provided an elevating cylinder part provided below the movable pressing plate and configured in order for the movable pressing plate to move at a predetermined angle, and an elevating rotary shaft part configured to carry out the function of a rotary shaft, whereby a separation work can be more readily carried out in such a way to bend and separate at a predetermined angle a plurality of stacked original plates before the movable pressing-separation part moves backward.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a planar figure view illustrating a conventional die-cut packing box;

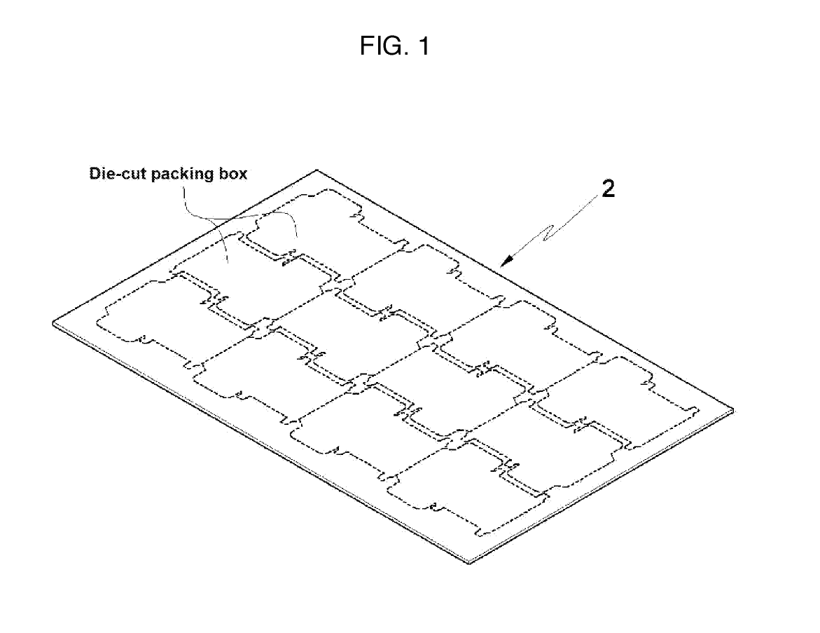

FIG. 2 is a side view illustrating a conventional die-cutting scrap removal device;

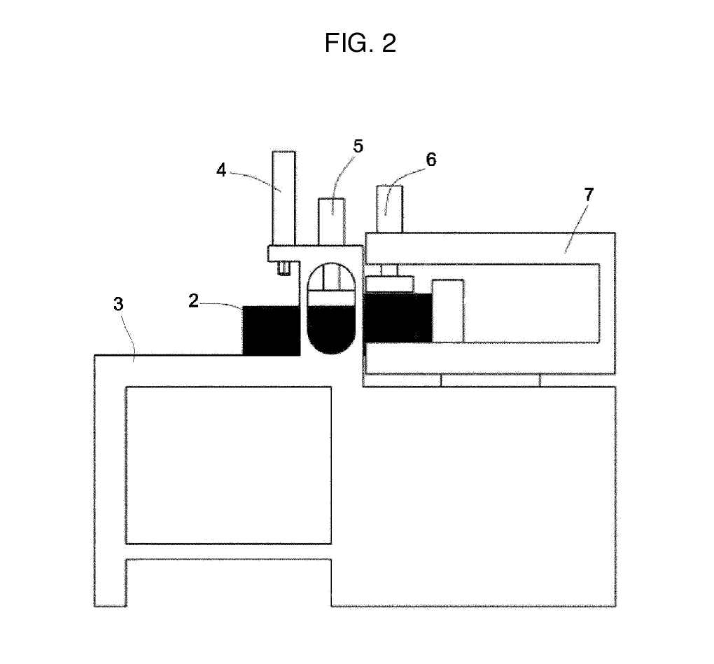

FIG. 3 is a perspective view illustrating a die-cutting scrap removal device according to the present invention;

FIG. 4 is a disassembled perspective view illustrating a scrap removal part according to the present invention;

FIG. 5 is a front view illustrating a scrap removal part according to an embodiment of the present invention;

FIG. 6 is a plane cross sectional view illustrating a scrap removal part according to an embodiment of the present invention;

FIG. 7 is a perspective view illustrating a pressing body and a plurality of pressing pins according to the present invention; and

FIG. 8 is a side view illustrating a scrap removal part according to an embodiment of the present invention, of which FIG. 8A is a view for describing a backward movement operation, and FIG. 8B is a view for describing a bending operation.

### DETAILED DESCRIPTION

The preferred embodiments of the present invention will be described with reference to the accompanying drawings.

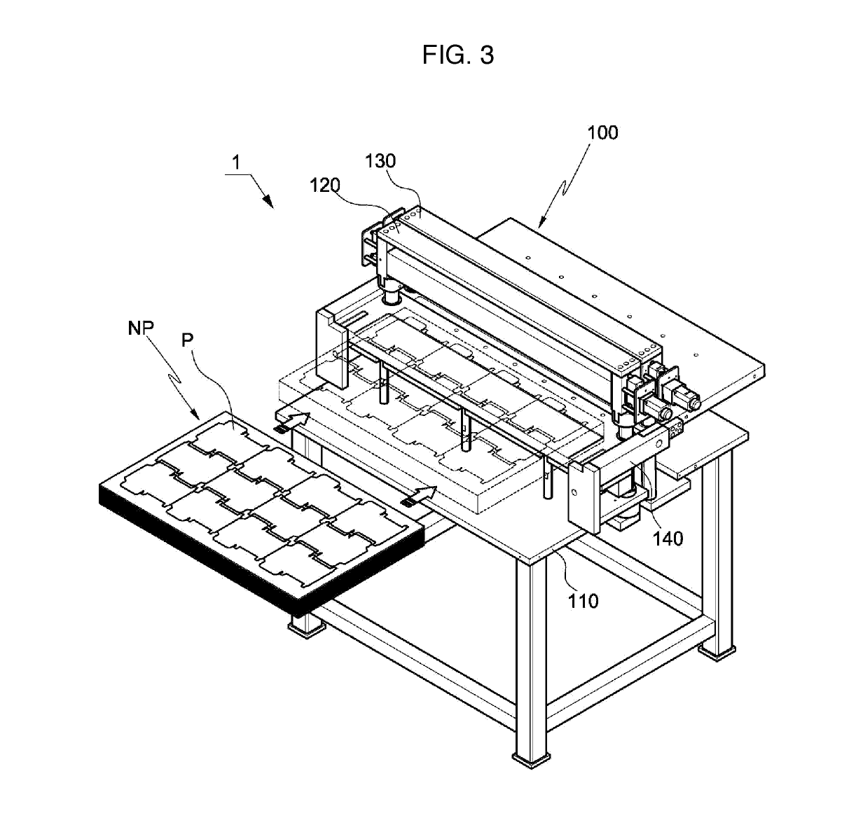

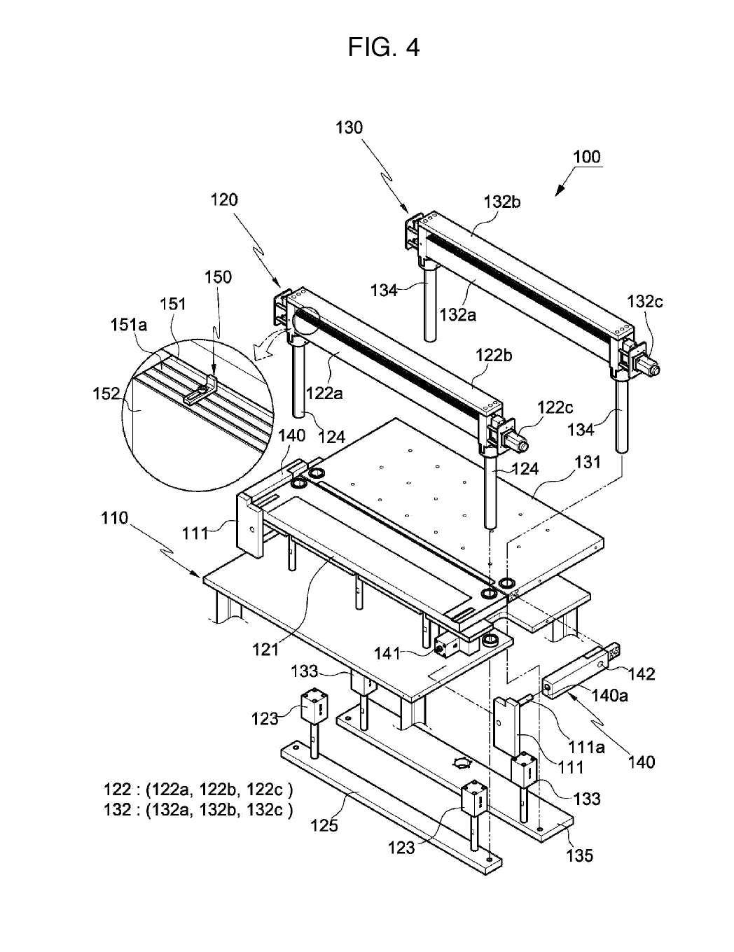

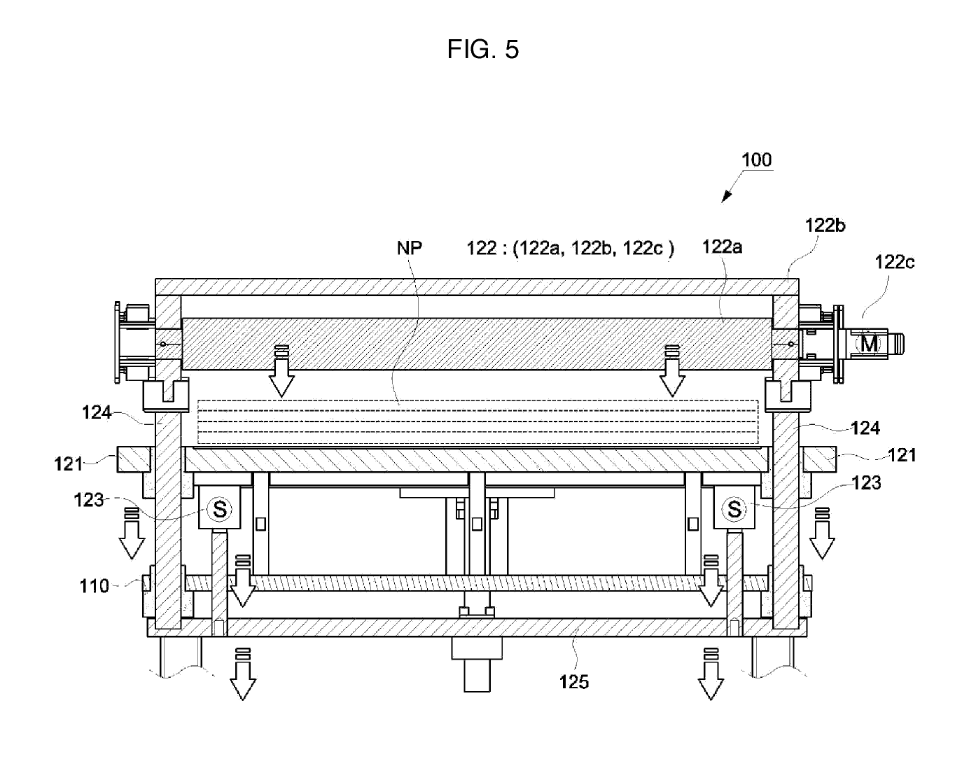

The die-cutting scrap removal device according to the present invention, as illustrated in FIGS. 3 to 6, is directed to a die-cutting scrap removal device 1 which is able to separate products (P) from an original plate (NP) on which a plurality of products (P) have been die-cut and may include, but is not limited to, a scrap removal part 100 which is formed of a table-shaped removal main body part 110 which stands upright on the ground, a fixed pressing-separation part 120 which is fixed on the upper surface of the removal main body part 110 and is configured to move vertically, and a movable pressing-separation part 130 which is configured to move back and forth and vertically on the upper surface of the removal main body part 110.

The fixed pressing-separation unit 120 may include a fixed pressing plate 121 on which an original plate (NP) loaded on the top of the removal main body part 110, is mounted, a fixed pressing part 122 which is configured to move vertically above the fixed pressing plate 121 and is connected passing through for the original plates (NP) to be pressed, and a fixed pressing cylinder 123 which is disposed below the fixed pressing plate 121 and is able to move vertically the fixed pressing part 122.

Moreover, the movable pressing-separation part 130 may include a movable pressing plate 131 which is disposed horizontal behind the fixed pressing plate 121 and is configured to move back and forth, a movable pressing part 132 which is configured to move vertically above the movable pressing plate 131 and is connected passing through for the original plates (NP) to be pressed, and a movable pressing cylinder 133 which is disposed below the movable pressing plate 131 and allows to move vertically the movable pressing part 132.

Furthermore, a pair of fixed vertical shaft rods 124 are disposed at the fixed pressing-separation part 120 so as to guide the vertical movements of the fixed pressing part 122. A fixed pressing transfer plate 125 is disposed at a lower end portion of the fixed vertical shaft rod 124 and is connected to the fixed pressing cylinder 123 and is able to move the fixed pressing part 122. A pair of movable vertical shaft rods 134 are disposed at the movable pressing-separation part 130 so as to guide the vertical movement of the movable pressing part 132. A movable pressing transfer plate 135 is disposed at a lower end portion of the movable vertical shaft rod 134 is connected to the movable pressing cylinder 133 and is able to move the movable pressing part 132.

Meanwhile, it is preferred that a plurality of ball bearing housings (not illustrated) are disposed at the fixed vertical shaft rod 124 and the movable vertical shaft rod 134 while passing through the fixed pressing plate 121 and the movable pressing plate 131.

Moreover, the fixed pressing part 122 may include a quadrangular rod-shaped fixed pressing body 122a, a [symbol] -shaped fixed pressing body frame 122b to which both ends of the fixing pressing body 122a are connected rotatable, and a fixed rotation motor 122c which is disposed at one side of the fixed pressing body frame 122b and is configured to rotate the fixed pressing body 122a. The movable pressing part 132 may include a quadrangle rod-shaped movable pressing body 132a, a [symbol] -shaped movable pressing body frame 132b to which both ends of the movable pressing body 132a are connected rotatable, and a movable rotation motor 132c which is disposed at one side of the movable pressing body frame 132b and is able to rotate the movable pressing body 132a.

Meanwhile, the [symbol] -shapes of the fixed pressing body frame 122b and the movable pressing body frame 132b correspond to the shapes of the lateral cross sections thereof.

In addition, a pin fixing surface 151 may be formed at one surface of each of the fixed pressing body 122a and the movable pressing body 132b, wherein the pin fixing surface 151 is formed of a pressing pin 150 which allows one point of the original plate (NP) to be pressed and fixed, and a pin engaging hole 151a which is formed inwardly concave for the pressing pin 150 to be fixed. A plane fixed surface 152 may be formed at the other surface thereof for another point of the original plate (NP) to be pressed and fixed.

It is preferred that the pin engaging hole 151a is formed concave in a row in the longitudinal directions of the fixed pressing body 122a and the movable pressing body 132a.

The pressing pin 150 may include a mounting part 150a which is mounted on the pin fixing surface 151, and a pressing part 150b which is bent at a right angle at an end portion of the mounting part 150a. A longitudinal bolt through hole 150a′ may be formed at one surface of the mounting part 150a for an engaging bolt (B) to pass through the longitudinal bolt through hole 150a′.

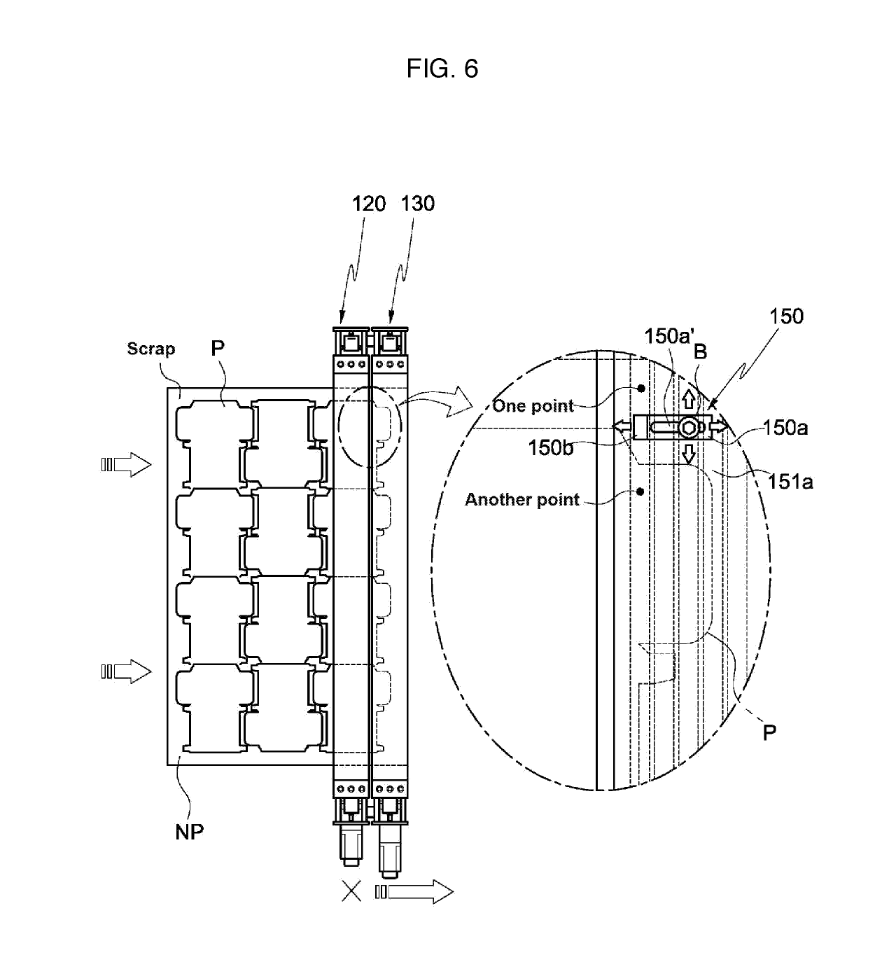

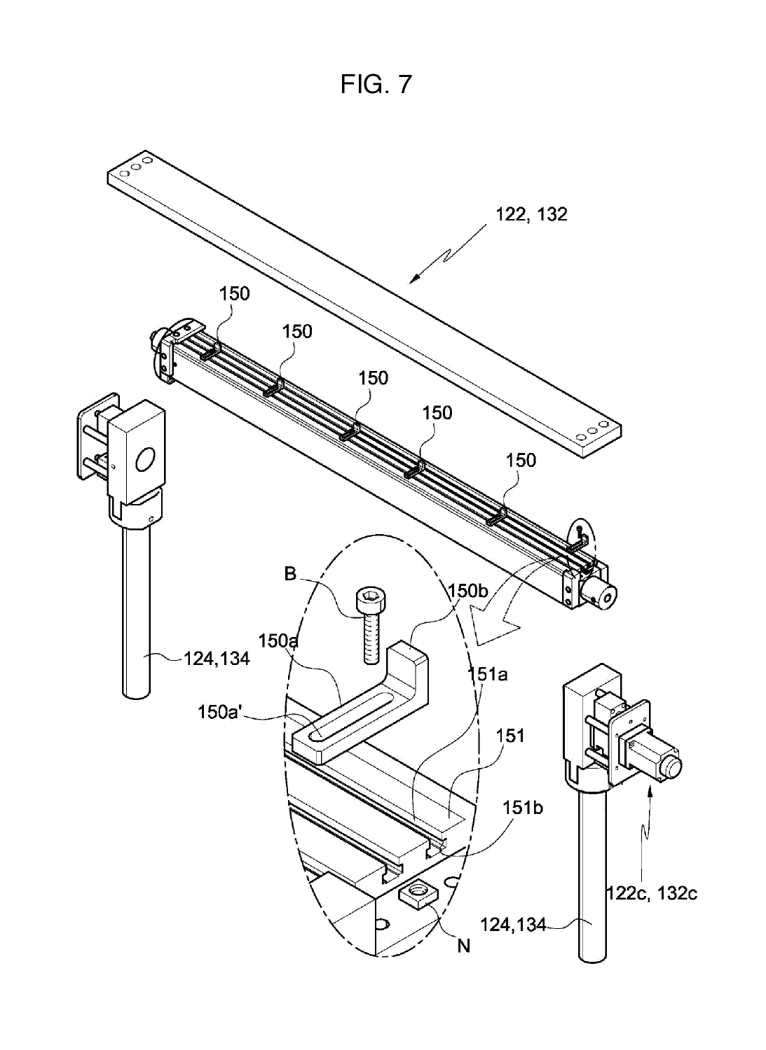

Referring to FIGS. 6 and 7, in the pressing pin 150, an engaging groove 151b may be formed at an inner side of the pin engaging hole 151a, wherein the engaging groove 151b is formed outwardly concave. An engaging nut (N) may be provided at the engaging groove 151b and may be engaged with the engaging bolt (B), wherein the engaging nut (N) is larger than the inner diameter of the pin engaging hole 151a for the pressing pin 150 to be fixed.

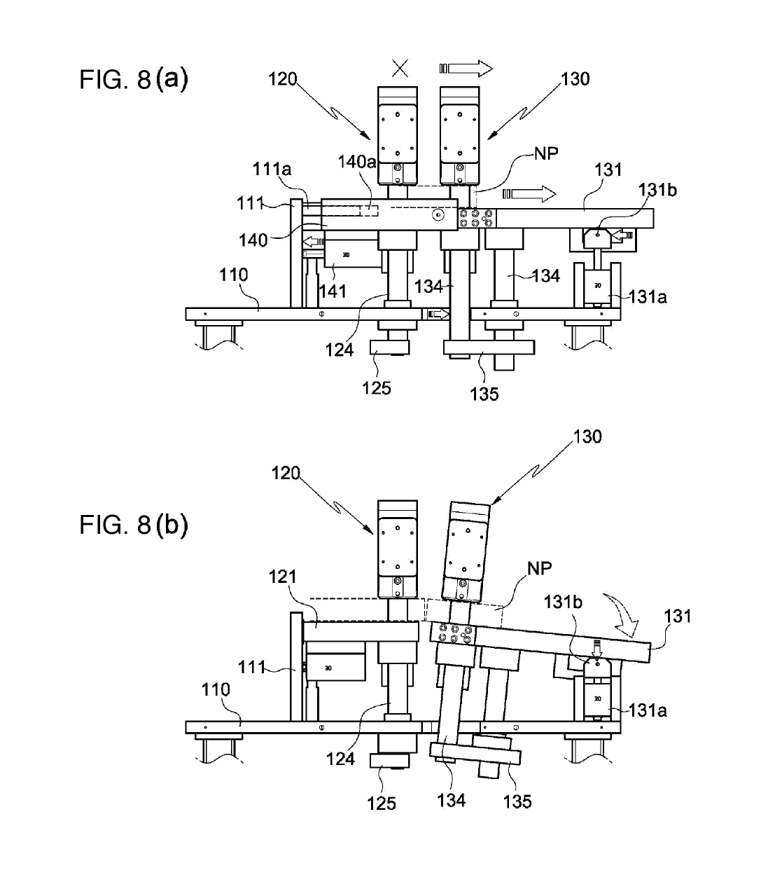

Moreover, as illustrated in FIG. 8, a forward and backward movement guide bar 140 may be formed at both sides of the movable pressing plate 131 while protruding in the direction of the fixed pressing plate 121, wherein a slide insertion hole 140a is formed inside the forward and backward movement guide bar 140. A plate-shaped forward and backward movement guide plate 111 may be disposed on the upper surface of the removal main body part 110, wherein the slide insertion rod 111a inserted in the slide insertion hole 140a is formed horizontal. A forward and backward movement cylinder 140 may be provided below the forward and backward movement guide bar 140 and is configured to push the forward and backward movement guide plate 111.

It is preferred that the forward and backward movement cylinder 141 is engaged to one surface of the forward and backward movement guide plate 111.

Meanwhile, it is preferred that a longitudinal movement vertical shaft rod connection hole (not illustrated) is formed on the upper surface of the removal main body part 110 in order for a movable vertical shaft rod 134 to readily move back and forth when the movable pressing plate 131 moves back and forth.

Moreover, a rotation hinge part 142 may be disposed at an end portion of the forward and backward movement guide bar 140 while being fixed at both sides of the movable pressing plate 131 so as to rotate in the upward and downward directions of the movable pressing plate 131, wherein the rotation hinge part 142 is hinged at an end portion of the forward and backward movement guide bar 140.

Furthermore, an elevating cylinder part 131a may be disposed at the lower surface of one side of the movable pressing plate 131 and may be configured to elevate the movable pressing plate 131 in order for the movable pressing plate 131 to move at a predetermined angle. An elevating rotary shaft part 131b may be disposed at an upper end portion of the elevating cylinder part 131a and may be connected to the movable pressing plate 131 so as to rotate during the elevating operation.

In the meantime, it is preferred that a longitudinal movable rotation part 131c may be formed at the elevating rotary shaft part 131b so as to prevent any interference when the movable pressing plate 131 moves backward.

The operation of the thusly constituted die-cutting scrap removal device according to the present invention will be described below.

Referring to FIGS. 3 to 6, the die-cutting scrap removal device according to the present invention is directed to a die-cutting scrap removal device 1 which is able to separate the products (P) from the original plates (NP) on which a lot of products (P) have been die-cut.

There is provided the scrap removal part 100 wherein a point between the products (P) on a plurality of the original plates (NP) on which various shape planar figures have been die-cut, is pressed, and subsequently one side thereof is fixed, and the other side thereof is moved in the direction of the backside, whereby the product (P) can be easily separated from the original plate (NP).

The aforementioned scrap removal part 100 includes the fixed pressing-separation part 120 equipped with a fixed pressing cylinder 123 at a lower portion thereof for the sake of only a vertical movement, and the movable pressing-separation part 130 equipped with a movable pressing cylinder 133 and a forward and backward movement cylinder 141 which are disposed behind the fixed pressing-separation part 120 so as to carry out the vertical movement and the forward and backward movements at the same time, by which the product (P) can be readily separated from the original plate (NP).

Referring to FIGS. 6 to 8, the fixed pressing cylinder 123 is configured to operate in the downward direction. The fixed pressing cylinder 123 is able to elevate the fixed pressing part 122 connected via the fixing vertical shaft rod 124 to the fixing pressing transfer plate 125 while moving the fixed pressing transfer plate 125, and the movable pressing cylinder 133 is able to elevate the movable pressing part 132 connected via the movable vertical shaft rod 134 to the movable pressing transfer plate 135 while moving the movable pressing transfer plate 135.

Moreover, the forward and backward movement cylinder 141 is engaged to one side of the forward and backward movement guide plate 111. The forward and backward movement cylinder 141 is able to move backward the movable pressing-separation part 130 when the rod of the forward and backward movement cylinder 141 comes out, and is able to move backward the movable pressing-separation part 130 when the rod goes in.

The forward and backward movement guide bar 140 is employed to insert the slide insertion rod 111a of the forward and backward movement guide plate 111, by which it is possible to prevent the movement trajectory from being deformed during the operation of the forward and backward movement cylinder 141.

Furthermore, a polyhedron-shaped fixed pressing body 122a and movable pressing body 132a are disposed at the fixed pressing-separation part 120 and the movable pressing-separation part 130 so as to prevent any damages to the product (P) when pressing the original plates (NP) and substantially fixing a point of the product (P). Any damages to the product (P) which might occur during the work to separate the product (P) from the original plate (NP), can be prevented in such a way to press a point of the original plate (NP) or the product (P) with the aid of the plane fixed surface 152 formed at the fixed pressing body 122a or the movable pressing body 132a.

As illustrated in FIGS. 6 and 7, the pressing pin 150 may allow easily move the pressing part 150b to the point thanks to the presence of a longitudinal bolt through hole 150a′ and the pin engaging hole 151a formed concave in a row in the direction of one side.

In the meantime, an engaging groove 151b formed inwardly concave at in both directions in the cross section shape of the inverted “T” may be disposed at the inner side of the pin engaging hole 151a of the pin engaging hole 151a, and an engaging nut (N) which is larger than the inner diameter of the pin engaging hole 151a, may be provided at the engaging groove 151b, whereupon the pressing pin 150 can be easily fixed after it has been moved to the point.

Since the fixed rotation motor 122c and the movable rotation motor 132c are provided at one side for the fixed pressing body 122a and the movable pressing body 132a to be rotatable, necessary works can be readily carried out while easily moving the pin fixing surface 151 and the plane fixing surface 152 in response to the position of the original plate (NP).

Moreover, since the elevating cylinder 131a configured to elevate the movable pressing plate 131 for the movable pressing plate 131 to move at a predetermined angle is disposed at the lower surface of one side of the movable pressing plate 131, and the elevating rotary shaft part 131b is disposed at the lower surface of the other side, a plurality of the original plates (NP) can be separated in such a way that they are bent rotating about the elevating rotary shaft part 131b during when the elevating cylinder part 131a operates, whereupon workability can be greatly enhanced.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

Legend of reference numbers

| | |
|---|---|
| 1: Scrap removal device | 100: Scrap removal part |
| 110: Removal main body part | 111: Forward and backward movement |
| | guide plate |
| 111a: Slide insertion rod | 120: Fixed pressing-separation part |
| 121: Fixed pressing plate | 122: Fixed pressing part |
| 122a: Fixed pressing body | 122b: Fixed pressing body frame |
| 122c: Fixed rotation motor | 123: Fixed pressing cylinder |
| 124: Fixed vertical shaft rod | 125: Fixed pressing transfer plate |
| 130: Movable pressing- | 131: Movable pressing plate |
| separation part | |
| 131a: Elevating cylinder part | 131b: elevating rotary shaft part |
| 132: Movable pressing part | 132a: Movable pressing body |
| 132b: Movable pressing body | 132c: Movable rotation motor |
| frame | |
| 133: Movable pressing cylinder | 134: Movable vertical shaft rod |
| 135: Movable pressing transfer | 140: Forward and backward movement |
| plate | guide bar |
| 140a: Slide insertion hole | 141: Forward and backward movement |
| | cylinder |
| 142: Rotation hinge part | 150: Pressing pin |
| 150a: Mounting part | 150b: Pressing part |
| 150a′: Bolt through hole | 151: Pin fixing surface |
| 151a: Pin engaging hole | 151b: Engaging groove |
| B: Engaging bolt | N: Engaging nut |
| 152: Plane fixed surface | 150a′: Pin fixed cut-away part |
| NP: Original plate | |

1. A die-cutting scrap removal device configured to separate a product from an original plate on which a plurality of products have been die-cut, comprising:
a scrap removal means which includes a table-shaped removal main body part which stands upright on the ground, a fixed pressing-separation part which is fixed on the upper surface of the removal main body part and is configured to move vertically, and a movable pressing-separation part which is able to move back and forth and vertically on the upper surface of the removal main body part,
wherein the fixed pressing-separation part includes a fixed pressing plate on which an original plate loaded on the top of the removal main body part, is mounted, a fixed pressing part which moves vertically above the fixed pressing plate and is connected passing through for the original plate to be pressed, and a fixed pressing cylinder which is disposed below the fixed pressing plate and is configured to move vertically the fixed pressing part, and
wherein the movable pressing-separation part includes a movable pressing plate which is disposed horizontal behind the fixed pressing plate and is configured to move back and forth, a movable pressing part which is configured to move vertically above the movable pressing plate and is connected passing through for the original plate to be pressed, and a movable pressing cylinder which is disposed below the movable pressing plate and is configured to move vertically the movable pressing part.

2. The device of claim 1, wherein a pair of fixed vertical shaft rods are disposed at the fixed pressing-separation part so as to guide the vertical movements of the fixed pressing part, and a fixed pressing transfer plate is disposed at a lower end portion of the fixed vertical shaft rod and is connected to the fixed pressing cylinder and is able to move the fixed pressing part, and a pair of movable vertical shaft rods are disposed at the movable pressing-separation part so as to guide the vertical movement of the movable pressing part, and a movable pressing transfer plate is disposed at a lower end portion of the movable vertical shaft rod is connected to the movable pressing cylinder and is able to move the movable pressing part.

3. The device of claim 1, wherein the fixed pressing part includes a quadrangular rod-shaped fixed pressing body, a [symbol] -shaped fixed pressing body frame to which both ends of the fixing pressing body are connected rotatable, and a fixed rotation motor which is disposed at one side of the fixed pressing body frame and is configured to rotate the fixed pressing body, and the movable pressing part includes a quadrangle rod-shaped movable pressing body, a [symbol] -shaped movable pressing body frame to which both ends of the movable pressing body are connected rotatable, and a movable rotation motor which is disposed at one side of the movable pressing body frame and is able to rotate the movable pressing body.

4. The device of claim 3, wherein a pin fixing surface is formed at one surface of each of the fixed pressing body and the movable pressing body, wherein the pin fixing surface is formed of a pressing pin which allows one point of the original plate to be pressed and fixed, and a pin engaging hole which is formed inwardly concave for the pressing pin to be fixed, and a plane fixed surface is formed at the other surface thereof for another point of the original plate to be pressed and fixed.

5. The device of claim 4, wherein the pressing pin includes a mounting part which is mounted on the pin fixing surface, and a pressing part which is bent at a right angle at an end portion of the mounting part, and a longitudinal bolt through hole is formed at one surface of the mounting part for an engaging bolt to pass through the longitudinal bolt through hole.

6. The device of claim 5, wherein an engaging groove is formed at an inner side of the pin engaging hole, wherein the engaging groove is formed outwardly concave, and an engaging nut is provided at the engaging groove and is engaged with the engaging bolt, wherein the engaging nut is larger than the inner diameter of the pin engaging hole for the pressing pin to be fixed.

7. The device of claim 1, wherein a forward and backward movement guide bar is formed at both sides of the movable pressing plate while protruding in the direction of the fixed pressing plate, wherein a slide insertion hole is formed inside the forward and backward movement guide bar, and a plate-shaped forward and backward movement guide plate is disposed on the upper surface of the removal main body part, wherein the slide insertion rod inserted in the slide insertion hole is formed horizontal, and a forward and backward movement cylinder is provided below the forward and backward movement guide bar and is configured to push the forward and backward movement guide plate.

8. The device of claim 7, wherein a rotation hinge part is disposed at an end portion of the forward and backward movement guide bar while being fixed at both sides of the movable pressing plate so as to rotate in the upward and downward directions of the movable pressing plate, wherein the rotation hinge part is hinged at an end portion of the forward and backward movement guide bar.

9. The device of claim 1, wherein an elevating cylinder part is disposed at the lower surface of one side of the movable pressing plate and is configured to elevate the movable pressing plate in order for the movable pressing plate to move at a predetermined angle, and an elevating rotary shaft part is disposed at an upper end portion of the elevating cylinder part and is connected to the movable pressing plate so as to rotate during the elevating operation.
